(19) United States
(12) Patent Application Publication
(10) Pub. No.: US 2008/0230032 A1
(43) Pub. Date: Sep. 25, 2008

(54) METHOD FOR THE PRODUCTION OF A CYLINDER CRANKCASE, AND CYLINDER CRANKCASE PRODUCED ACCORDING TO SAID METHOD

(76) Inventors: Eduard Koehler, Heilbronn (DE); Bernd Sommer, Oehringen (DE)

Correspondence Address: Muncy, Geissler, Olds & Lowe, PLLC, P.O. BOX 1364, FAIRFAX, VA, 22038-1364, US

(21) Appl. No.: 12/059,405

(22) Filed: Mar. 31, 2008

Related U.S. Application Data
(63) Continuation of application No. PCT/EP2006/009479, filed on Sep. 29, 2006.

(30) Foreign Application Priority Data
Sep. 30, 2005 (DE) DE102005047435.7

(51) Int. Cl. F02F 1/00; B22D 27/09; C22C 21/02

(52) U.S. Cl. 123/193.2; 164/47; 420/548

(57) ABSTRACT

A method for producing a cylinder crankcase is provided, in which a hypereutiectic aluminum-silicon alloy is cast in a rheocasting or thixocasting process and is cast at a temperature ranging from 520° C. to 580° C.

This nonprovisional application is a continuation of International Application No. PCT/EP2006/009479, which was filed on Sep. 29, 2006, and which claims priority to German Patent Application No. DE 10 2005 047 435.7, which was filed in Germany on Sep. 30, 2005, and which are both herein incorporated by reference.

### BACKGROUND OF THE INVENTION

1. Field of the Invention

The present invention relates to a method for producing a cylinder crankcase for an internal combustion engine made of a hypereutectic aluminum-silicon alloy, and also relates to a cylinder crankcase manufactured according to the method.

2. Description of the Background Art

On account of the steadily increasing costs for energy and materials, efforts are underway in the automotive industry to save weight in order to reduce fuel consumption of automobiles with equal or improved performance. Since engines, in particular, have a critical influence on vehicle weight, the aim is to produce the cylinder crankcases of engines from light alloys. In diesel engines, this has the result that different materials have to be used, since conventional monolithic aluminum cylinder crankcases cannot handle the increased demands of diesel passenger car engines with or without direct injection. Areas that are especially highly stressed are the cylinder bores and the crankshaft bearing blocks. There, cylinder liners are cast from higher-strength alloys or infiltration bodies, for example. In this way, quasi-monolithic cases can be produced.

It is possible to omit the use of cylinder liners if the cylinder crankcase is made of a hypereutectic aluminum-silicon alloy. The hard, load-bearing primary precipitates are then available as a supporting structure for the piston rings and piston body. From DE 100 32 845 A1, for example, it is known to produce a cylinder crankcase of an engine in that the cylinder block part is made from a hypereutectic aluminum-silicon alloy by the low pressure chill casting, squeeze casting, or pressure die casting method, and the crankcase part is produced separately.

From DE 103 52 932 A1 is known a thixocasting and rheocasting method with which it is possible to make heavy-duty cast parts of aluminum alloys. Among other items, cast engine parts of a hypoeutectic aluminum-silicon alloy are also described.

A method for producing a composite cast part using the thixocasting method is described in DE 103 50 713 A1. Such composite cast parts are used, for example, as crankcases in motor vehicles powered by internal combustion engines. Aluminum-silicon alloys are among the materials mentioned here, as well.

A hypoeutectic aluminum-silicon alloy with which composite cast parts can also be manufactured in the thixocasting method is known from EP 1 308 227 A1. However, there is no indication in this document of a temperature for thixocasting.

The use of the rheocasting method for hypereutectic aluminum-silicon alloys is known from WO 2005/007912 A1. Typical temperature ranges cited therein for this method are temperatures between 600° C. and 850° C.

During casting of hypereutectic aluminum-silicon alloys, initial solidification of the primary silicon, with the consequent poor distribution of the silicon crystals and uncontrollable crystal growth in the region of the cylinder bores, repeatedly results in problems. It is also considered a disadvantage that the steel molds are subjected to high melting temperatures, in the range of approximately 800° C., during the casting of hypereutectic aluminum-silicon alloys in the conventional pressure die casting or squeeze casting methods, while temperatures of only approximately 680° C. come to bear in conventional aluminum alloys. Finally, as a result of the low viscosity of the molten aluminum-silicon alloys at the aforementioned high temperatures, it can happen that the liquid metal spurts out through the mold joints because of the high viscosity of the alloy.

### SUMMARY OF THE INVENTION

It is therefore an object of the present invention to provide a method by which cylinder crankcases for an internal combustion engine can be produced without problem from a hypereutectic aluminum-silicon alloy. In addition, a cylinder crankcase produced according to the method is a further object of the invention, wherein the cylinder crankcase must be designed without reinforcements in the region of the cylinder bores.

### DETAILED DESCRIPTION

In an embodiment of the invention, the cylinder crankcase is produced in the rheocasting or thixocasting method and is cast in a temperature range from 520° C. to 580° C. The casting methods of thixocasting and rheocasting proposed here are closely related to one another and thus are often also referred to as rheocasting/thixocasting. Rheocasting refers to a die casting method in which a metal is melted and then is cooled under stirring back to the semifluid state between solidus and liquidus temperatures. A preferred temperature range here is the range between 520° C. and 580° C., since a uniform material grain can be achieved in this way. The semifluid light alloy with a predetermined viscosity is finally processed into a final product by casting or forging. Thixocasting refers to a method in which rods that have been produced in the rheocasting method are heated into the semifluid state with a predetermined viscosity, and the semifluid material is then made into the final products by casting or forging. This method utilizes the thixotropic material behavior of the alloys employed. A metal is thixotropic when it still behaves like a solid when at rest in the semifluid state, but flows like a slightly viscous fluid under the influence of shear forces.

Now, according to an embodiment of the invention, hypereutectic aluminum-silicon alloys are brought to the thixotropic state. Since hypereutectic aluminum-silicon alloys have a longer solidification interval than conventional hypoeutectic alloys, they are especially suitable for the methods proposed. Moreover, the structure of the hypereutectic alloys favors thixotropic behavior.

In addition, the problem of early silicon precipitation does not arise with hypereutectic aluminum-silicon alloys, since the semifluid precursor material, especially in thixocasting, already contains silicon in the correct grain size and distribution, so that the problems of initial solidification of the primary silicon associated with uncontrollable crystal growth are likewise eliminated. Moreover, the temperatures in rheocasting/thixocasting are lower than in conventional pressure die casting methods, so that the associated problems, in particular the problem of the fluid light alloy spurting out between the mold halves, do not occur.

Finally, it has become apparent that crankshaft housings made of hypereutectic aluminum-silicon alloys that have been produced by rheocasting/thixocasting have high strength and good ductility, with the result that the parts produced are fully heat-treatable and in some cases also weld well. Moreover, they have a fine material grain with only non-critical residual solidification zones where voids could form, since the fluid fraction is small. In comparison to conventional pressure die casting, low porosity and a gas content that is orders of magnitude lower are achieved such as cannot be achieved even using the vacuum die casting method.

In the context of producing cylinder crankcases of hypereutectic aluminum-silicon alloys, the thixocasting method is especially suitable, since rod sections of a precursor material are heated here to a semifluid state and then are placed in the casting chamber. The critical point is the radial temperature distribution because of the “skin effect” during inductive heating. The customary gating rates extend down to those customary in squeeze casting.

In contrast, the rheocasting method offers the advantage of simpler handling and, in particular, a great deal of latitude with regard to the fluid fraction and potential alloy modifications, so that one is not dependent on the supply of continuous casting rod precursor material, as well as simpler temperature control.

As a result, using rheocasting/thixocasting in producing cylinder crankcases from hypereutectic aluminum-silicon alloys, it is possible to produce monolithic components that do not require any additional reinforcement in the region of the cylinder bores and that are produced in a large-scale production process (die casting method).

Especially good results have been achieved with an aluminum-silicon alloy having a silicon content between 17 and 20 percent by weight, a copper content between 3 and 5 percent by weight, and small fractions of copper. Such an alloy, which is cast in a temperature range between 520° C. and 580° C. using a thixocasting method, has a homogeneous, and hence heavy-duty, material grain. In a cylinder crankcase produced using this method, the grain size of the silicon is between 35 μm and 100 μm. Moreover, such a cylinder crankcase can be identified by the grain count of approximately 15,000 crystals per cm², and can be subjected to the highest mechanical stresses.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a cylinder crankcase for an internal combustion engine from a hypereutectic aluminum-silicon alloy, the method comprising:
producing the cylinder crankcase in a thixocasting or rheocasting method; and
casting aluminum-silicon alloy in a temperature range from 520° C. to 580° C.

2. The method according to claim 1, wherein an aluminum-silicon alloy with 17 percent by weight to 20 percent by weight silicon and 3 percent by weight to 5 percent by weight copper is cast.

3. A cylinder crankcase according to claim 1, wherein silicon is present in a grain size from 35 μm to 100 μm in the cylinder crankcase.

4. The cylinder crankcase according to claim 3, wherein the silicon is present in the cylinder crankcase with a grain count of 15,000 crystals/cm².
